(19) United States
(12) Patent Application Publication
(10) Pub. No.: US 2017/0300359 A1
(43) Pub. Date: Oct. 19, 2017

(54) POLICY BASED WORKLOAD SCALER

(71) Applicant: HEWLETT PACKARD ENTERPRISE DEVELOPMENT LP, Houston, TX (US)

(72) Inventors: Sripadwallabha Dattatraya KOLLUR, Bangalore (IN); Swaroop JAYANTHI, Bangalore (IN); Venkata Chandra VARMA B, Bangalore (IN)

(21) Appl. No.: 15/517,454

(22) PCT Filed: Jan. 22, 2015
(86) PCT No.: PCT/US2015/012362

§ 371 Date: Apr. 6, 2017

(30) Foreign Application Priority Data
Oct. 30, 2014 (IN) 5428/CHE/2014

(51) Int. Cl. G06F 9/48; G06F 9/50

(52) U.S. Cl. CPC G06F 9/4881; G06F 9/5022; G06F 2209/5022

(57) ABSTRACT

In one implementation, a system for policy based workload scaler includes a parameters engine to define external factors for a number of resources providing a number of cloud service workloads, a threshold engine to define a threshold value for the cloud service workloads from the number of resources, a priority engine to assign a priority to each of the number of cloud service workloads, and a service engine to reclaim resources from a first portion of cloud service workloads with a first priority and allocate the reclaimed resources to a second portion of cloud service workloads when the threshold value is exceeded and the external factors are exceeded.

### BACKGROUND

In cloud computing environments there can be a limited set of resources and/or quotas to external factors such as cost constraints, storage disk space, network bandwidth, power consumption, among other external factors. Resources can be scaled out based on the scaling decisions made by aggregating and correlating alerts from a monitoring tool. It is not always possible to scale out resources. For example, it may not be possible to scale out resources when resource utilization exceeds a threshold and there are no additional resources available for scaling out.

### BRIEF DESCRIPTION OF THE DRAWINGS

FIG. 1 illustrates a diagram of an example of a system for a policy based workload scaler according to the present disclosure.

FIG. 2 illustrates a diagram of an example computing device according to the present disclosure.

FIG. 3 illustrates a flow chart of a policy based workload scaler according to the present disclosure.

FIG. 4 illustrates a flow chart of a policy based workload scaler according to the present disclosure.

FIG. 5 is a flow chart of a method for resource scheduling according to the present disclosure.

### DETAILED DESCRIPTION

A policy based workload scaler can be utilized to assign a priority to each of a plurality of cloud service workloads. In some embodiments, the priority can be a value assigned to each of the plurality of cloud service workloads to indicate an importance of performing each of the plurality of cloud service workloads. In some embodiments, the priority can be a value assigned to each of a plurality of tenants that own or operate the plurality of cloud service workloads. For example, a priority can be assigned to each of the plurality of cloud service workloads and a priority can be assigned to each of a plurality of tenants. In this example, the proposed systems and methods can check a priority assigned to the cloud service workload and check the priority assigned to the tenant when scaling the plurality of cloud service workloads.

The priority values for the plurality of cloud service workloads can be categorized and stored within a database to determine what cloud service workloads can be reclaimed in the event that maximum limits are reached for external factors associated with physical and/or logical resources. As used herein, external factors define maximum limits on available resources for each workload or tenant in a given cloud environment. For example, an external factor can include, but is not limited to: cost constraints for a given cloud service workload or tenant, a maximum available network bandwidth, a maximum available disk space, and/or a maximum available power.

In some embodiments, a monitoring tool (e.g., Ceilometer, etc.) can be utilized to monitor the plurality of cloud service workloads and determine when a cloud service workload from the plurality of cloud service workloads exceeds a predetermined threshold value. When the monitoring tool identifies a cloud service workload that has exceeded a threshold value the policy based workload scaler can perform a number of actions to continue the service of the identified cloud service workload.

In some embodiments, the policy based workload scaler can attempt to scale out the identified cloud service workload when the external factors allow for scaling out the identified cloud service workload. In some embodiments, if the identified cloud service workload is not able to be scaled out due to the external factors, the policy workload scaler can attempt to increase the predetermined threshold value. In some embodiments, if the identified cloud service workload is not able to have an increased threshold value, the policy workload scaler can trigger a resource reclaiming engine to reclaim physical and/or logical resources from cloud service workloads with a relatively lower priority value and allocate the reclaimed resources to cloud service workloads with a relatively higher priority value. As used herein, reclaiming physical and/or logical resources includes partially or completely shutting down cloud service workloads and utilizing the partially reclaimed or shutdown resources for other cloud service workloads.

The policy based workload scaler can provide a systematic way of reclaiming resources from lower priority cloud service workloads and associating the reclaimed resources to higher priority cloud service workloads when external factors do not allow for scaling out or increasing threshold values associated with the cloud service workloads. The policy based workload scaler can automatically reclaim resources to associate the reclaimed resources to higher priority cloud service workloads based on the priority value assigned to the cloud service workload and/or the priority value assigned to the tenant of the cloud service workload without a human user interaction which can lead to mistakes.

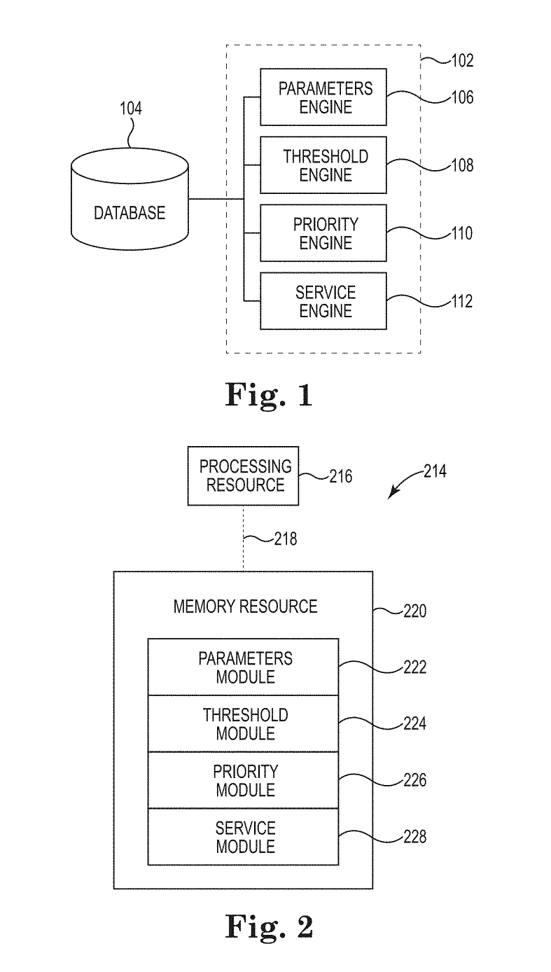

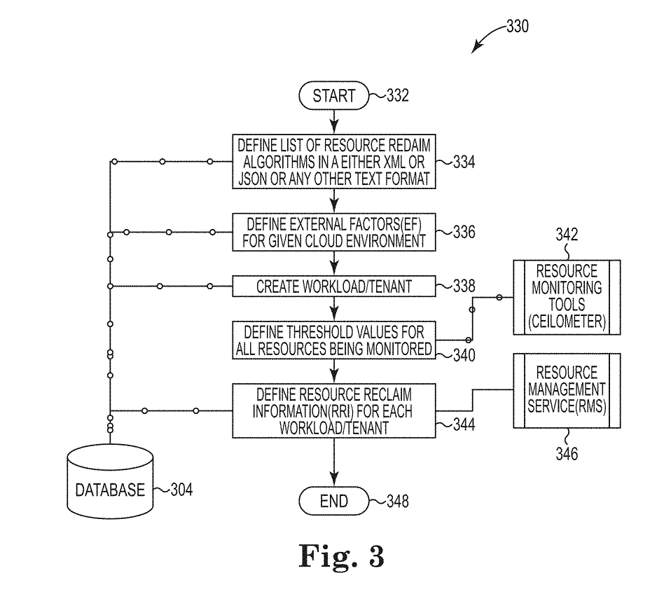

FIGS. 1 and 2 illustrate examples of system 100 and computing device 214 according to the present disclosure. FIG. 1 illustrates a diagram of an example of a system 100 for a policy based workload scaler according to the present disclosure. The system 100 can include a database 104, a policy based workload scaler system 102, and/or a number of engines (e.g., parameters engine 106, threshold engine 108, priority engine 110, service engine 112). The policy based workload scaler system 102 can be in communication with the database 104 via a communication link, and can include the number of engines (e.g., parameters engine 106, threshold engine 108, priority engine 110, service engine 112). The policy based workload scaler system 102 can include additional or fewer engines that are illustrated to perform the various functions as will be described in further detail in connection with FIGS. 3-5.

The number of engines (e.g., parameters engine 106, threshold engine 108, priority engine 110, service engine 112) can include a combination of hardware and programming, but at least hardware, that is configured to perform functions described herein (e.g., define external factors for a number of resources providing a number of cloud service workloads, define a threshold value for the cloud service workloads from the number of resources, assign a priority to each of the number of cloud service workloads, reclaim resources from a first portion of cloud service workloads with a first priority and allocate the reclaimed resources to a second portion of cloud service workloads when the threshold value is exceeded and the external factors are exceeded, etc.). The programming can include program instructions (e.g., software, firmware, etc.) stored in a memory resource (e.g., computer readable medium, machine readable medium, etc.) as well as hard-wired program (e.g., logic).

The parameters engine 106 can include hardware and/or a combination of hardware and programming, but at least hardware, to define external factors for a number of resources providing a number of cloud service workloads. The external factors for a number of resources can include, but is not limited to: cost constraints for a given cloud service workload or tenant, a maximum available network bandwidth, a maximum available disk space, and/or a maximum available power associated with a number of physical and/or logical resources. The external factors can be defined and stored in the database 104 for utilization by the number of engines (e.g., parameters engine 106, threshold engine 108, priority engine 110, service engine 112).

The threshold engine 108 can include hardware and/or a combination of hardware and programming, but at least hardware, to define a threshold value for the cloud service workloads from the number of resources (e.g., physical and/or logical resources). Defining a threshold value for the cloud service workloads can include defining a maximum value of physical and/or logical resource utilization for a corresponding cloud service workload. In some embodiments, the threshold engine 108 can determine what maximum values, that when exceeded by the cloud service workloads, produces an alert.

In some embodiments, the threshold engine 108 can store the threshold values in the database 104. The threshold values stored in the database can be utilized by a monitoring engine such as Ceilometer to determine when a particular cloud service workload has exceeded the threshold value.

The priority engine 110 can include hardware and/or a combination of hardware and programming, but at least hardware, to assign a priority to each of the number of cloud service workloads and/or tenants corresponding to the number of cloud service workloads. The priority that is assigned to each of the number of cloud service workloads can be a value that indicates a relative importance of a particular cloud service workload compared to other cloud service workloads operating within a particular data center or number of physical and/or logical resources.

The priority can be based on a cost associated with performing and/or not performing the particular cloud service workload. For example, there can be a financial benefit (e.g., cost benefit) of performing the particular cloud service workload and/or a financial detriment (e.g., cost detriment) associated with not performing the particular cloud service workload. That is, a cost of operation can be associated to the priority of a particular clouds service workload. In this example, cloud service workloads with a relatively high financial benefit for completion and/or high financial detriment for non-completion can be determined to have a relatively high priority.

The cost of operation can be determined for each of the number of cloud service workloads and/or for each of the number of tenants associated with the number of cloud service workloads. In some embodiments, the cost of operation can also include a quantity of time required to reclaim resources associated with the number of cloud service workloads and reassign the reclaimed resources to a number of different cloud service workloads. For example, the cost of operation can be affected by the quantity for time required to reclaim resources and associate the reclaimed resources to other cloud service workloads. That is, a greater quantity of time can increase financial costs since the resources may not be providing services while they are being reclaimed and associated to other cloud service workloads.

In some embodiments, determining the priority of a first and second number of cloud service workloads includes determining a cost associated with performing the first and second number of cloud service workloads. In some embodiments, the cost of not performing the first number of cloud services can be greater than the cost of not performing the second number of cloud service workloads plus the cost associated with reclaiming resources from the second number of cloud service workloads.

The priority can also be based on a quantity of physical and/or logical resources that are utilized to perform the cloud service workload. For example, the priority can be based on how many other cloud service workloads can be performed on the same number of resources as a particular cloud service workload.

The service engine 112 can include hardware and/or a combination of hardware and programming, but at least hardware, to reclaim resources from a first portion of cloud service workloads with a first priority and allocate the reclaimed resources to a second portion of cloud service workloads when the threshold value is exceeded and the external factors are exceeded. In some embodiments, the first priority can be a priority that is relatively lower than the second priority. In some embodiments, the service engine 112 can perform a number of functions to allocate physical and/or logical resources when an alert is received that a particular cloud service workload has exceeded the determined threshold associated with the particular cloud service workload.

The service engine 112 can utilize the external factor values and/or the stored priority values stored in the database 104 to determine if the resources of a particular cloud service workload should be reclaimed and allocated to a different cloud service workload. In some embodiments, the service engine 112 can determine if the resources associated with the particular cloud service workload should be reclaimed and associated to the different cloud service workload based on the priority value. In some embodiments, the service engine can determine if the resources associated with the particular cloud service workload should be reclaimed based on the external factor values associated with the particular cloud service workload and the external factor values associated with the different cloud service workload. In some embodiments, the service engine 112 can reclaim physical and/or logical resources by lowering a threshold associated with a portion of cloud service workloads and associating the reclaimed physical and/or logical resources to a portion of cloud service workloads with a relatively higher priority.

As described herein the priority based workload scaler system 102 can automatically reclaim resources from a number of lower priority cloud service workloads and associate the reclaimed resources to a number of higher priority resources without a human user interaction.

FIG. 2 illustrates a diagram of an example computing device 214 according to the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a desired function (e.g., define a threshold value for each of a number of cloud service workloads running on a number of resources, monitor the number of cloud service workloads, determine a first cloud service workload that has exceeded the defined threshold value, determine a first priority of the first cloud service workload, reclaim resources from a second cloud service that has a second priority that is less than the first priority, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., parameters module 222, threshold module 224, priority module 226, service module 228) can include CRI that when executed by the processing resource 216 can perform functions. The number of modules (e.g., parameters module 222, threshold module 224, priority module 226, service module 228) can be sub-modules of other modules. For example, the threshold module 224 and the priority module 226 can be sub-modules and/or contained within the same computing device. In another example, the number of modules (e.g., parameters module 222, threshold module 224, priority module 226, service module 228) can comprise individual modules at separate and distinct locations (e.g., CRM, etc.).

Each of the number of modules (e.g., parameters module 222, threshold module 224, priority module 226, service module 228) can include instructions that when executed by the processing resource 216 can function as a corresponding engine as described herein. For example, the parameters module 222 can include instructions that when executed by the processing resource 216 can function as the parameters engine 106. In another example, the threshold module 224 can include instructions that when executed by the processing resource 216 can function as the threshold engine 108. In another example, the priority module 226 can include instructions that when executed by the processing resource 216 can function as the priority engine 110. In another example, the service module 228 can include instructions that when executed by the processing resource 216 can function as the service engine 112.

FIG. 3 illustrates a flow chart 330 of a policy based workload scaler according to the present disclosure. The flow chart 330 can represent how the policy based workload scaler as described herein can determine when a cloud service workload has exceeded a predetermined threshold and how the policy based workload scaler can reclaim resources and allocate the reclaimed resources to high priority cloud serve workloads.

The flow chart 330 can start at 332. The flow chart 330 can define a list of resource reclaim engines (e.g., resource reclaim hardware comprising resource reclaim methods) at box 334. The defining a list of resource reclaim engines can include defining a method associated with the resource reclaim engines in code (e.g., extensible markup language (XML), java script object notation (JSON), other text format, etc.).

The defined list of resource reclaim engines can be sent and stored in the database 304. The defined list of resource reclaim engines can be utilized by other resources and/or engines associated with the policy based workload scaler. For example, the list of resource reclaim engines can be utilized by a service engine (e.g., service engine 112 as referenced in FIG. 1, etc.) when it is determined that a particular cloud service workload requires the scale engine to reclaim the resources associated with the cloud service workload and associate the reclaimed resources to a different cloud service workload.

In some embodiments, the defined list of resource reclaim engines can include resource reclaim information for each cloud service workload and/or for each tenant. The resource reclaim information can be defined at the time of creating the cloud service workload. The resource reclaim information can include, but is not limited to: a workload ID, a tenant ID, resources required for the cloud service workload, and/or a priority ID for the cloud service workload. In some embodiments, the defined list of resource reclaim engines can include a particular resource reclaim algorithm to be used in the event that a particular cloud service workload exceeds a threshold and/or exceeds a maximum threshold due to defined external factors.

The flow chart 330 can include defining external factors for a cloud service environment that is performing the cloud service workloads. Defining external factors for a cloud service environment can include defining external factors for each of a plurality of cloud service workloads and/or tenants utilizing the cloud service environment. As described herein, the external factors can include: cost constraints for a given cloud service workload or tenant, a maximum available network bandwidth, a maximum available disk space, and/or a maximum available power. Thus, defining the external factors can include defining external factors can include defining a maximum value for each of the external factors.

The flow chart 330 can include creating a cloud service workload at box 338. Creating the cloud service workload can include specifying parameters of the cloud service workload. Specifying parameters of the cloud service can include specifying instances to be executed when performing a particular function. As described herein, creating the cloud service workload can include defining external factors at box 336 and/or defining a list of resource reclaim engines at box 334 that are associated with the cloud service workload. The created cloud service can be stored in the database 304 and executed by the cloud service network.

The flow chart 330 can include defining threshold values for a number of physical and/or logical resources associated with each of the number of cloud service workloads. Defining the threshold values can include defining threshold values for the defined external factors. The threshold values can be values below the defined maximum value defined at box 336. The threshold values can be values that when exceeded by a particular cloud service workload can initiate an alert from a resource monitoring tool 342 (e.g., Ceilometer, etc.).

The flow chart 330 can include defining resource reclaim information for each cloud service workload and/or tenant of a plurality of cloud service workload tenants. The resource reclaim information can be assigned to each individual cloud service workload. The resource reclaim information can include, but is not limited to: workload ID information, tenant ID to which workload belongs, resources required for a workload (e.g., minimum, ideal, max amount of resources), priority ID of a workload, and/or priority ID of a tenant. The resource reclaim information can be utilized to reclaim resources associated with a cloud service workload with a relatively low priority value and associate the reclaimed resources to a cloud service workload with a relatively high priority value.

The flow chart 330 can be implemented by a resource management service 346. The resource management service 346 can be implemented by a system and/or computing device as referenced in FIG. 1 and FIG. 2 respectively. The resource management service 346 can be utilized to reclaim resources based on the information associated with each of the number of cloud service workloads. For example, the resource management service 346 can reclaim resources based on: the resource reclaim engine defined at box 334, the external factors defined at box 336, and/or the resource reclaim information defined at box 344. The resource management service 346 can access the database 304 to obtain and/or utilize the information associated with each of the number of cloud service workloads.

The flow chart 330 can end at 348. The flow chart 330 can be implemented to create cloud service workloads with corresponding information relating to reclaiming resources from low priority resources and associating the reclaimed resources to high priority resources.

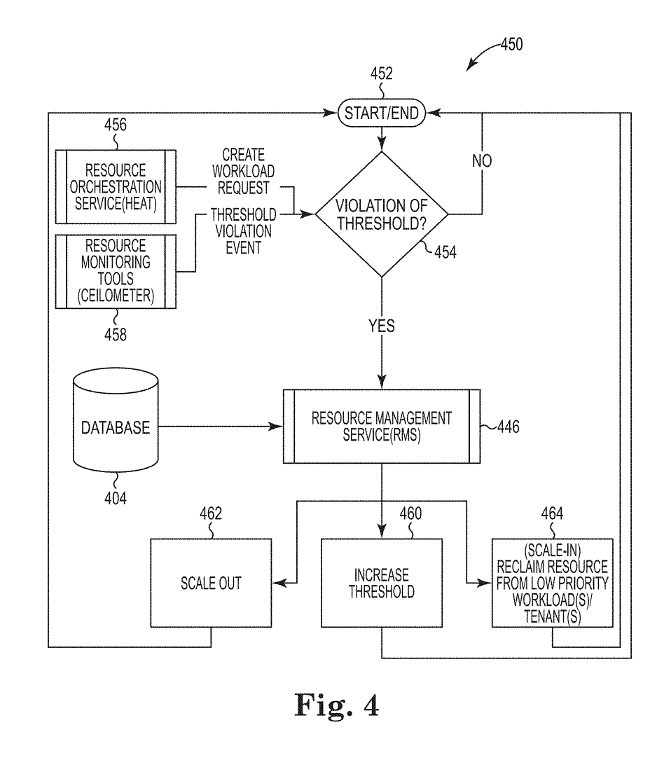

FIG. 4 illustrates a flow chart 450 of a policy based workload scaler according to the present disclosure. The flow chart 450 can be utilized to scale a cloud service network implementing a number of cloud service workloads. The flow chart 450 can start at 452.

The flow chart 450 can determine if a defined threshold has been exceeded at 454. A determination at 454 can be made based on information received from the resource orchestration service 456 and/or a resource monitoring tool 458. When there is a violation of the threshold at 454 the flow chart 450 can move to a resource management service 446. The resource management service 446 can be communicatively coupled to a database 404. As described herein, the database 404 can store information relating to scaling the cloud service workload. The information can include: resource reclaim engine information, external factors information, and/or resource reclaim information as described herein.

The resource management service 446 can utilize the information relating to scaling the cloud service to perform a number of resource reclaim methods 460, 462, 464. The number of resource reclaim methods 460, 462, 464 can include an increase threshold method 460, a scale out method 462, and/or a reclaim resource method 464. In some embodiments, the resource management service 446 can attempt the scale out method 462 prior to attempting the increase threshold method 460 and/or the reclaim resource method 464. That is, the resource management service 446 can attempt to add a number of physical and/or logical resources to the cloud service workloads. In some embodiments, there are no additional physical or logical resources to add in order to increase the threshold of a number of cloud service workloads.

When there are no additional physical or logical resources for scaling out the number of cloud service workloads the resource management service 446 can attempt the increase threshold method 460. The resource management service 446 can utilize the increase threshold method 460 to increase a particular threshold defined for a particular number of cloud service workloads. In some embodiments, the threshold of the number of cloud service workloads may not be capable of being increased. For example, a particular cloud service workload can already be operating at a maximum level. In another example, there may be no additional physical or logical resources to increase the threshold of a particular cloud service workload. In some embodiments, the resource management service 446 can attempt the increase threshold method 460 prior to attempting the reclaim resource method 464.

When the resource management service 446 is unable to increase the threshold via the increase threshold method 460, the resource management service 446 can attempt the reclaim resource method 464. As described herein, the reclaim resource method 464 can include reclaiming a number of resources associated with cloud service workloads with a relatively low priority. Reclaiming the number of resources can include implementing a resource reclaim method (e.g., resource reclaim algorithm) with the resource reclaim information stored in the database 404.

In some embodiments, the resource management service 446 only attempts the reclaim resource method 464 when maximum limits are reached due to identified external factors. For example, the external factors can be available network bandwidth and the resource management service 446 can attempt the reclaim resource method only when the available network bandwidth is at a maximum level with no additional network bandwidth available.

As described herein, the resource management service 446 can reclaim resources from a first number of cloud service workloads and associate the reclaimed resources to a second number of cloud service workloads. As described herein, the first number of cloud service workloads can have a lower priority value compared to the second number of cloud service workloads. In some embodiments, reclaiming resources from cloud service workloads can include shutting down low priority cloud service workloads to free up physical and/or logical resources. The reclaimed resources from the cloud service workloads can be assigned to a number of cloud service workloads with a relatively higher priority value.

The flow chart 450 provides automated processing and scaling of cloud service workloads even when a scaling out method or an increase threshold method are not possible due to external factors. The flow chart 450 can be utilized to maintain consistent operation of cloud service workloads without the possibility of human error. In addition, flow chart 450 maintains cloud service workloads that have a greater overall priority and a greater overall financial benefit.

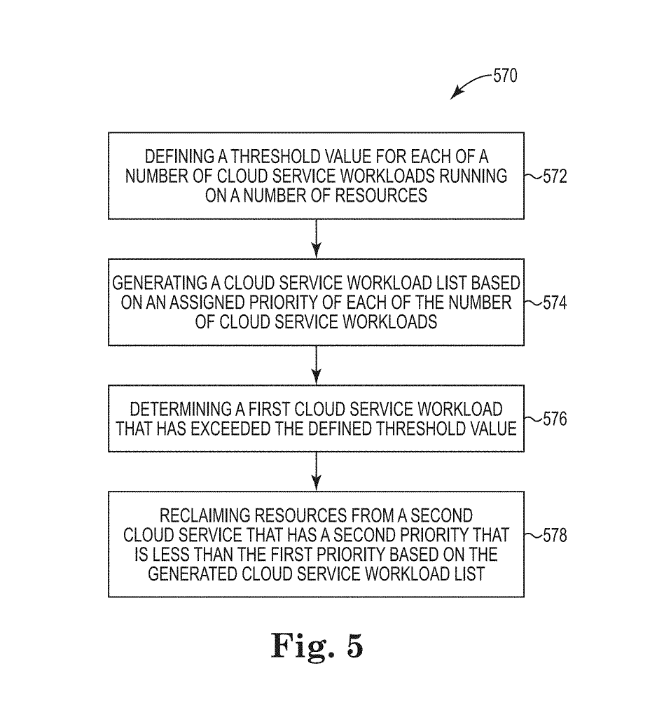

FIG. 5 is a flow chart of a method 570 for resource scheduling according to the present disclosure. The method 570 can be utilized to scale a plurality of cloud service workloads operating on a cloud service network. The method 570 can be executed by a system 102 as referenced in FIG. 1 and/or a computing device 214 as referenced in FIG. 2.

At box 572 the method 570 can include defining a threshold value for each of a number of cloud service workloads running on a number of physical and/or logical resources. As described herein defining the threshold value for each of a number of cloud service workloads can include determining a number of external factor maximum limits and defining the threshold values based on the external factor maximum limits. For example, a threshold for disk space can be based on the external factor maximum for disk space within a physical resource associated with a particular cloud service workload.

At box 574 the method 570 can include generating a cloud service workload list based on an assigned priority of each of the number of cloud service workloads. The cloud service workload list can be a list of cloud service workloads operating from a particular data center and/or a list of cloud service workloads operating from one or more cloud service networks spanned across one or more datacenters. The cloud service workload list can be a list comprising cloud service workloads with a greatest priority at a top of the list (e.g., portion of list with greatest priority) with cloud service workloads with a relatively lower priority towards a bottom of the list (e.g., portion of list with least priority). In addition, the cloud service workload list can be a list comprising a priority value of a tenant that corresponds to the cloud service workload. For example, a cloud service workload can have an assigned priority value and a tenant that corresponds to the cloud service workload can have an assigned priority value. In this example, the priority value of the workload and the priority value of the tenant can be utilized to generate the cloud service workload list.

The cloud service workload list can be utilized to easily compare a number of cloud service workloads to determine which cloud service workload from the number of cloud service workloads has a highest priority from the number of cloud service workloads. When comparing the number of cloud service workloads the priority value assigned to each cloud service can be compared as well as the priority value assigned to the corresponding tenants of the number of cloud service workloads can be compared. In some embodiments, a cloud service workload can be positioned on the cloud service workload list based on a combination of the priority assigned to the cloud service workload and the priority assigned to the tenant associated with the cloud service workload. For example, a first cloud service workload with a first tenant can be relatively higher on the cloud service workload list than a second cloud service workload with a second tenant when the first tenant has a relatively higher priority value than the second tenant. In this example, the first cloud service workload can have a relatively lower priority than the second cloud service workload and still have a higher priority since it is associated with a tenant that has a higher priority value.

In some embodiments the cloud service workload list is based on a financial cost associated with each of the number of cloud service workloads. For example, the priority of a particular cloud service workload can be based on the financial cost associated with performing and/or not performing the particular cloud service.

The priority can be based on a number of factors as described herein. The priority can be a value that represents how much cost is associated with completion of a cloud service workloads and/or how much cost is associated with non-completion of the cloud service workloads. The cost can include financial benefit (e.g., money received upon completion) and/or financial detriment (e.g., money spent upon non-completion). In some embodiments, the cost can include a financial cost of shutting down a particular cloud service workload and/or a financial cost of slowing down a particular cloud service workload.

In some embodiments the method 570 can include associating a financial cost to each of the number of cloud service workloads. Associating the financial cost to each of the number of cloud service workloads can include associating the financial cost to the priority information associated with each of the number of cloud service workloads.

At box 576 the method 570 can include determining a first cloud service workload that has exceeded the defined threshold value. Determining the first cloud service workload has exceeded the defined threshold value can include utilizing a resource monitoring tool (e.g., Ceilometer, etc.) to monitor resource utilization for the first cloud service workload. In addition, the resource monitoring tool can utilize defined threshold values that are stored in a database to compare the defined threshold values to the real-time resource utilization values. If the real-time resource utilization exceeds the threshold value, the resource monitoring tool can issue an alert to a resource management service that the first cloud service workload is in violation of a defined threshold.

At box 578 the method 570 can include reclaiming resources from a second cloud service that has a second priority that is less than the first priority based on the generated cloud service workload list. The physical and/or logical resources can be reclaimed from the second cloud service by a resource management service utilizing a reclaim resource method (e.g., reclaim resource method 464 as referenced in FIG. 4). Reclaiming the physical and/or logical resources from a second cloud service can include shutting down the second cloud service and utilizing the resources that operated the second cloud service for the first cloud service. That is, the physical and/or logical resources from the second cloud service are reclaimed and associated to the first cloud service.

In some embodiments, the method 570 can include determining a first cost associated with providing each of the number of cloud service workloads. The cost associated with providing each of the number of cloud service workloads can include a quantity of resources associated with each of the number of cloud service workloads. In some embodiments, the greater quantity of resources associated with a cloud service workload can increase the cost associated with the cloud service workload. In some embodiments, a cost of not providing or providing at a relatively lower rate of service can also be associated with each of the number of cloud service workloads. For example, there can be a financial cost associated with not performing a particular cloud service workload.

In some embodiments, the method 570 can include determining a second cost associated with reclaiming resources from the second cloud service workload and associating the reclaimed resources to the first cloud service workload. The second cost associated with reclaiming resources and associating the reclaimed resources can include a quantity of time that the resources are not providing a cloud service workload. For example, there can be a cost associated with not utilizing a physical and/or logical resources of a number of data centers.

In some embodiments, the method 570 can include determining a third cost comprising a difference between the first cost associated with providing the first cloud service workload and a fourth cost associated with not providing the second cloud service workload plus the second cost associated with reclaiming resources from the cloud service. The third cost can be a financial cost associated with the process of reclaiming resources from the second cloud service workload and associating the reclaimed resources to the first cloud service workload. As described herein, the third cost can include the cost of reclaiming resources plus the cost of not performing the second cloud service workload at a current level utilizing the reclaimed resources.

The method 570 can automatically detect that a threshold has been violated and identify a need to reclaim resources. For example, a need to reclaim resources can include an inability to scale out resources or increase the threshold value due to external factors. The method 570 can provide for a better scaling method compared to previous systems and methods by eliminating human error and providing a method of scaling cloud computing resources when maximum levels are reached for external factors.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system for a policy based workload scaler, comprising:
a parameters engine to define external factors for a number of resources providing a number of cloud service workloads;
a threshold engine to define a threshold value for the cloud service workloads from the number of resources;
a priority engine to assign a priority to each of the number of cloud service workloads; and
a service engine to reclaim resources from a first portion of cloud service workloads with a first priority and allocate the reclaimed resources to a second portion of cloud service workloads when the threshold value is exceeded and the external factors are exceeded.

2. The system of claim 1, wherein the service engine reclaims resources when the threshold value is at capacity for the number of resources.

3. The system of claim 1, wherein the service engine reclaims resources by shutting down the first portion of cloud service workloads.

4. The system of claim 1, wherein the service engine reclaims resources by increasing a threshold associated with the first portion of cloud service workloads.

5. The system of claim 1, wherein the priority engine is configured to assign a priority to each of the number of cloud service workloads based on a tenant utilizing the cloud service workloads.

6. The system of claim 1, comprising a cost engine to associate a cost of operation to the priority.

7. The system of claim 6, wherein the cost includes a financial cost of shutting down a particular cloud service workload and a financial cost of slowing down a particular cloud service workload.

8. A non-transitory computer readable medium storing instructions executable by a processing resource to cause a controller to:
define a threshold value for each of a number of cloud service workloads running on a number of resources;
monitor the number of cloud service workloads;
determine a first cloud service workload that has exceeded the defined threshold value;
determine a first priority of the first cloud service workload; and
reclaim resources from a second cloud service that has a second priority that is less than the first priority.

9. The medium of claim 8, comprising instructions to associate a financial cost to each of the number of cloud service workloads.

10. The medium of claim 9, wherein the first priority and the second priority are based on the associated financial cost of the corresponding cloud service workload.

11. The medium of claim 8, wherein the threshold value is a maximum percentage of resource utilization.

12. A method for resource scheduling, comprising:
defining a threshold value for each of a number of cloud service workloads running on a number of resources;
generating a cloud service workload list based on an assigned priority of each of the number of cloud service workloads;
determining a first cloud service workload that has exceeded the defined threshold value; and
reclaiming resources from a second cloud service workload that has a second priority that is less than the first priority based on the generated cloud service workload list.

13. The method of claim 12, wherein the cloud service workload list is based on a financial cost associated with each of the number of cloud service workloads.

14. The method of claim 12, comprising:
determining a first cost associated with providing each of the number of cloud service workloads;
determining a second cost associated with reclaiming resources from the second cloud service workload and associating the reclaimed resources to the first cloud service workload; and
determining a third cost comprising a difference between the first cost associated with providing the first cloud service workload and a fourth cost associated with not providing the second cloud service workload plus the second cost associated with reclaiming resources from the cloud service.

15. The method of claim 12, wherein the cloud service workload list is based on a tenant associated with each of the number of cloud service workloads.
